(19) United States
(12) Patent Application Publication
(10) Pub. No.: US 2007/0143153 A1
(43) Pub. Date: Jun. 21, 2007

(54) Demand tracking system and method for a transportation carrier

(75) Inventors: Roger J. Ashby, Edina, MN (US); Robert T. Wilson, Minneapolis, MN (US)

Correspondence Address: UNISYS CORPORATION;MS 4773, PO BOX 64942, ST. PAUL, MN, 55164-0942, US

(73) Assignee: Unisys Corporation

(21) Appl. No.: 11/312,302

(22) Filed: Dec. 20, 2005

(51) Int. Cl. G06Q 10/00

(52) U.S. Cl. 705/5

(57) ABSTRACT

An automated system and method for tracking and recording demand for the services (e.g., flights) provided by a transportation carrier are disclosed. According to the invention, selected availability request that are soliciting information regarding the availability of services are recorded. Further, selected booking requests are recorded regardless of whether those requests result in the sale of a service. The requests that are captured may be selected using programmable business rules. The captured request data may be provided as input to a demand forecasting system that analyzes demand for the services. In one embodiment, a notification module is provided to automatically issue notifications to authorized employees based on the captured request data. Such notifications may be used to alert one or more employees to take the appropriate actions, as may be needed to address unforeseen demand.

### RELATED APPLICATIONS

The following commonly-assigned Patent Applications have some subject matter in common with the current Application, all of which were filed on even date herewith:

Ser. No. ______ entitled “Rules-Driven Status and Notification System for a Transportation Carrier”, attorney docket number RA-5774;

Ser. No. ______ entitled “Allocation Limits System and Method for a Transportation Carrier”, attorney docket number RA-5775;

Ser. No. ______ entitled “Market-Level Inventory Control System and Method”, attorney docket number RA-5776; and

Ser. No. ______ entitled “System and Method for Managing Customer-Based Availability for a Transportation Carrier”, attorney docket number RA-5777.

### FIELD OF THE INVENTION

The present invention relates generally to a mechanism for managing route availability within a transportation system; and, more specifically, to a system and method for tracking demand for particular transportation services.

### BACKGROUND OF THE INVENTION

Transportation carriers such as airlines, trains, bus companies and the like generally employ some type of reservation and departure control system. Such systems are used to book passengers, track baggage, and manage departures and arrivals. These types of systems share a common need to match the number of routes that service particular locations with the demand to travel to, or from, those locations. For example, commercial airlines must determine the number of flights that will be provided from an origin such as Minneapolis/St. Paul to a destination such as Washington, D.C. within a particular time period. Optimally, the number of seats available to service this origin and destination at a particular price and within a particular time period will very closely match the number of people traveling between these locations during this time period that are willing to pay that price.

If the market is analyzed incorrectly so that route demand does not match the number of seats available at a given price that services a particular origin/destination city pair, the carrier will not operate at an optimal profit margin. That is, if too many seats are available at a given price, the seats will either go unbooked, or will be sold for a price that is cheaper than the original market model dictates. In either case, the carrier will not make its intended profit, and may even experience a loss for that route. Conversely, if not enough seats are available to meet demand, the carrier may be forfeiting revenue. In this type of situation, it may be beneficial to increase the price of some of the seats to match the demand. Alternatively or additionally, the carrier may be able to increase profits by adding routes or by increasing the size of the craft that is servicing the existing routes. For example, an airline may be able to profitably fill additional flights between the origin and destination.

Carriers utilize demand tracking and forecasting systems in attempt to match demand with the number of seats being provided. Prior art demand tracking systems record the number of bookings that are occurring for given routes within particular periods of time. Such recorded data may indicate, for instance, that a particular flight between Minneapolis and Washington D.C. is routinely overbooked. This may result in the addition of another flight that leaves either slightly before, or after, the departure time of that original flight. As another example, data recorded by a demand tracking system may identify a flight that is frequently flying at only half of its capacity, or for which the seats are being sold, but only at heavily discounted price. Such flights may be eliminated entirely, or may be replaced by a flight carried on a smaller aircraft.

One problem with the type of prior art demand tracking mechanism described above is that it is based solely on information pertaining to actual bookings. Requests for flights that do not result in the booking of one or more seats are never recorded. For instance, assume that a popular flight is already overbooked such that no further seats are available for sale. No record is maintained of the number of requests made to purchase a seat on this flight after all seats are sold. Thus, the airline has no reasonable way to predict how many additional seats could be profitably added for that flight. Other information associated with these requests is likewise being lost. For example, there will be no record of the number of first-class seat requests that were forfeited in a given period of time because the plane was full. Similarly, there will be no indication of how many preferred passengers (e.g., frequent fliers) were turned away because of seat unavailability. All of this information may have been useful to a carrier hoping to maximize profits and maintain passenger loyalty.

Another type of information that is lost by prior art demand recording systems involves request levels that are occurring during particular periods of time. It may be useful to know that a very large number of requests for flights were unexpectedly submitted to the carrier within a particular date range, for instance. This may be used to identify an oversight on the part of the carrier.

The type of request information discussed above may be useful in determining “look-to-book” ratios for various types of shopping forums. A look-to-book ratio compares the number of requests to purchases seats (i.e., “book requests”) to the number of requests soliciting information pertaining to flight availability (i.e., “look requests”). For instance, it may be helpful for an airline to know how many requests for a given flight are made from a particular web site to obtain availability information, and how many of those requests actually result in the sale of one or more seats. This information may be used to determine the effectiveness of the web site as a sales tool, for instance.

What is needed, therefore, is an enhanced information gathering tool that can be utilized to obtain information to improve demand tracking for a transportation carrier that will address the foregoing, and other, limitations.

### SUMMARY OF THE INVENTION

The current invention relates to a system and method for tracking and recording demand for the services provided by a transportation carrier. According to the system and method, all, or a selectable portion of all, of the availability requests seeking flight availability information are recorded. Further, the system may selectively record some or all of the booking requests, including any of the booking requests that did not result in a sale of a service (that is, did not result in a booking). The captured request data may then be provided as input to a demand forecasting system that may determine, for instance, whether transportation services (e.g., flights) must be added or cancelled, whether equipment should be changed for one or more services, whether schedules should be altered, and so on, to meet the recorded demand.

According to one embodiment, all availability and booking requests are provided to a demand recording module of a reservation and departure control system (RDCS). The demand recording module includes logic to determine which of these availability and booking requests will be captured. In one embodiment, this determination is made using programmable business rules that are interpreted by a rules engine.

As one example of the foregoing, an authorized inventory control agent of an airline may determine that a study will be performed to ascertain demand for flights from Minneapolis to Madison or Milwaukee departing November 23-27. Therefore, programmable rules are defined to cause a demand recording module to select and capture all availability requests associated with these flights. Information pertaining to these selected requests is captured for use in performing demand forecasting.

In general, the programmable rules that determine the types of availability requests to be captured may reference any of the data items provided with the availability requests. For instance, availability requests may include, without limitation, the source of the request (e.g., web site, travel agent, geographical location, etc.), the time and/or date on which the request was issued, the type of request (whether it was issued by price or schedule), the requested origin and destination of travel, requested time and date of travel, one or more flight numbers, a requested compartment, and customer information.

The programmable rules may reference any one or more of the above-described types of information to select the availability requests to be captured. For example, a programmable rule may be defined to capture all availability requests that originated from the “Orbitz.com” website and that are requesting availability of seats in the first-class compartment on flights from Minneapolis to Washington D.C. The selection criteria may be specified using Boolean logic (e.g., AND, OR, NOT). Any number of rules may be defined in this manner to select the availability requests.

In a similar manner, the programmable rules that determine the types of booking requests to be captured may reference any of the data provided with the booking requests. For instance, booking requests may include, without limitation, the source of the request (e.g., web site, travel agent, geographic location etc.), the time and/or date on which the request was issued, a specified price, the origin and destination of travel, requested time and/or date of travel, customer information, a specified price of a ticket, a booking class, and compartment (first class, coach, etc.). A booking request may further be associated with a status such as information indicating whether the request resulted in the purchase of seats. If desired, a rule may be defined to cause demand recording module to capture only those booking requests that did not result in a booking, for instance.

In addition to receiving the booking and availability requests, the demand recording module of one embodiment also receives a list of one or more services (e.g., flights) that would best satisfy the booking or availability request. These services may, or may not be, available. Demand recording module further receives a list of services that are actually available to satisfy the request. Any one or more portions of these lists may be stored with the other request information for use in forecasting demand and/or adjusting services in an appropriate manner.

As discussed above, the saved information is provided to specialized forecasting logic as input. This forecasting logic will perform analysis to determine any mismatches between the indicated demand and the services provided by the airline. For instance, the forecasting logic may determine that more flights must be added to service certain cities on a permanent, or a temporary, basis. Forecasting logic may further determine that other flights should be cancelled because of lack of demand.

The system and method of the current invention are of particular importance for identifying any unusual demand for one or more flights as indicated by very high request levels. For instance, an airline servicing a particular city may have inadvertently overlooked an upcoming event that warrants the temporary addition of more flights into, and out of, that city. The type of demand tracking system described herein may be programmed so that unusual request activity will be brought to the attention of the appropriate personnel. This allows such situations to be addressed in a timely manner without the forfeiture of revenue.

In one embodiment, a programmable notification module may optionally be provided to monitor request data so that the types of unusual request activity described above may be detected. Notification module may monitor request data as it is being stored, or after it is stored, and automatically issue notifications to authorized personnel of the carrier based on that data. The notification module of one embodiment utilizes a rules engine that interprets programmable business rules that are defined to determine when and how such notifications are to be issued.

As an example of the types of functionality provided by the notification module, this logic may be programmed via programmable rules to monitor requests for first-class seats on flights from Minneapolis to Madison on November 23. A notification will be issued if the request levels ever exceed a selected number of requests per hour. Such a notification may include an email message issued to one or more authorized employees. A notification might instead consist of an automatically-generated phone call, fax, page, the issuance of some type of written notice, or any other type of communication. This may allow one or more employees to take appropriate actions to address the unforeseen demand.

In one embodiment, the system further includes report generation logic to generate selected reports. Such reports may include any of the saved request and/or related information. Programmable business rules may be defined to determine the contents of such reports, as well as when such reports are to be generated.

According to one embodiment, a computer-implemented method for capturing data for a transportation carrier is disclosed. The method includes receiving a request, and determining, irrespective of whether the request will result in the sale of a service, whether the request is of a type for which associated data should be captured. If so, the associated data for the request is stored.

Another embodiment of the invention relates to an automated system for use by a transportation carrier in processing requests associated with provided services. The system includes a demand recording module for automatically storing selected requests based on data associated with the selected requests and without regard as to whether any of the selected requests resulted in a sale of any service. The system also includes a storage facility coupled to the demand recording module to store information for the selected requests.

According to another aspect of the invention, an automated system for capturing information describing a demand for transportation services is described. The system includes programmable request means for receiving requests associated with, but not resulting in sale of, the transportation services, and for selecting information to be stored for selected ones of the received requests. The system also includes storage means for storing the selected information.

Yet another aspect of the invention relates to a computer readable medium having a program to cause a system utilized by a transportation carrier to execute a method. The method includes receiving requests associated with, but not purchasing, services provided by the transportation carrier, and determining whether the received requests are of a type selected for capture. If so, selected information describing the requests of the selected type are stored to a storage facility.

Other scopes and aspects of the current invention will become apparent to those skilled in the art from the following description and the accompanying drawings.

### BRIEF DESCRIPTION OF THE DRAWINGS

FIG. 1 is a block diagram of one embodiment of a Reservation and Departure Control System according to the current invention.

FIG. 2 is a block diagram illustrating an exemplary embodiment of the Reservation and Departure Control System of FIG. 1 in further detail.

FIG. 3 is a block diagram of one embodiment of demand recording module according to the current invention.

FIG. 4 is a flow diagram illustrating one method of initializing the various capabilities of demand recording module.

FIG. 5 is a flow diagram illustrating the capturing of requests according to one embodiment of the invention.

FIG. 6 is a flow diagram illustrating the use of notification module according to one embodiment of the invention.

FIG. 7 is a flow diagram of a method of managing report generation according to one embodiment of the invention.

FIG. 8 is a diagram illustrating an exemplary screen such as may be used to define programmable rules in a system that employs a graphical user interface (GUI).

### DETAILED DESCRIPTION OF THE DRAWINGS

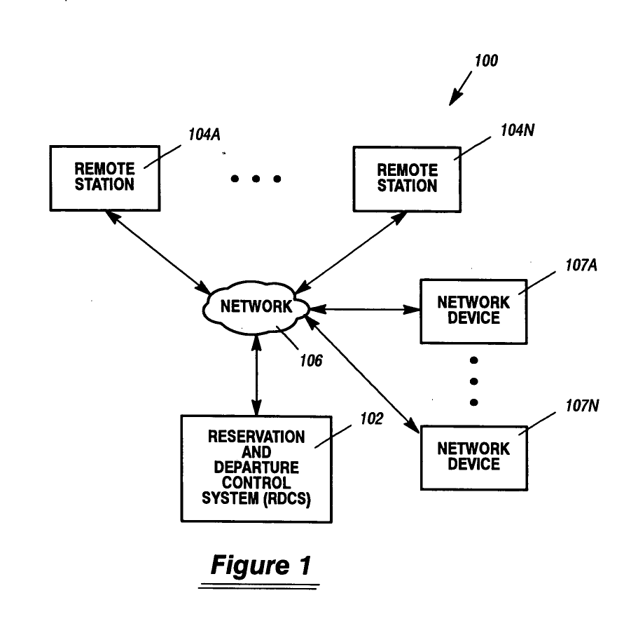

FIG. 1 is a block diagram illustrating an exemplary computing environment 100 in which a Reservation and Departure Control System (RDCS) 102 provides management and control services to a transportation carrier such as an airlines. While the following discussion will be described in reference to the airlines industry, it will be understood that this is merely for exemplary purposes, and that the RDCS may be adapted for use with any transportation provider, such as a bus company, a cruise line, a train service, and so on.

The services provided by RDCS may include, but are not limited to, request-handling capabilities, booking services, check-in functions, baggage-handling capabilities, and re-booking functions. In particular, RDCS provides request-handling services such as those that respond to requests inquiring on the availability of flights that serve one or more origin/destination location pairs. As part of this functionality, a recording function may be enabled to capture information describing requests that do not result in the booking of a flight. Information describing all requests may be captured, or alternatively, only information associated with one or more selected request types may be recorded. For instance, selected tracking may be enabled whereby only those requests that are made during a selected time period and that inquire about flight availability between one or more selected origin and destination points may be recorded. This information may then be used by a forecasting system to perform market analysis and optimize seat availability so that profits may be maximized.

RDCS 100 may be coupled to a network 106. Network 106 may be any private or public network such as the Internet or an intranet, and may include one or more Local Area Networks (LANs), Wide Area Network (WANs), wireless LANs or the like. Network 106 may also include one or more connected network-enabled computing devices, such as personal computers, laptop computers, handheld computers, workstations, servers, routers, switches, printers, fax machines or other devices. For ease of reference, these are represented by network devices 107A-107N. A network device executes communication software such as a web browser to communicate with RDCS 102.

Customers may utilize network devices to make requests for services to RDCS 102. For instance, a travel agent or a customer may utilize a personal computer to sign onto a web site that supports the electronic purchase of airline seats. This user may then request information describing the availability of flights between a selected origin and destination occurring at one or more times. Once this information is returned, the user may book one or more seats on an available flight. This will be discussed further below.

Also coupled to network 106 are remote stations 104A-104N that allow an authorized person to access RDCS using suitable communication software such as a web browser. Authorized personnel may include, for example, front-line staff, a system administrator, a control agent, a booking agent, or other authorized users. Exemplary tasks include retrieving basic customer data, booking passengers on a flight, performing check-in activities, re-booking a passenger from a first flight to a different flight, and generally accessing airline data and/or functionality supported by RDCS 102. Remote stations 104 may be associated with a single airline or multiple airlines. Although remote stations 104 are typically remotely located from RDCS 102, it will be understood that this need not be the case.

According to the current invention, remote stations 104 allow authorized airline personnel to access information that describes the number of, and/or types of, requests, being issued by potential customers. As discussed above, such customers may be making requests via network devices 107A-107N, for instance. Customers may also be making requests directly to airline personnel stationed at remote stations 104A-104N.

Authorized airline personnel may access the request information in several ways. They may access the raw request data, or may instead use reporting functions to generate reports that include some or all of the collected data in a selected format. Authorized airline personnel may further provide this request data as input to a demand forecasting system that utilizes the request data as input for generating forecasts of future demands. Authorized personnel may utilize the raw request data, resulting reports and/or forecasts to make business decisions. For instance, one or more flights may be added while other flights may be cancelled. The aircraft utilized for a given flight may be changed to increase or decrease the number of available flights. One or more booking classes may be added or cancelled, thereby changing the prices structure of the flight. Similarly, seats may be moved from one booking class to another to change the profit margin for the flight. Flight schedules may be modified based on demand. Other decisions that affect the business may be made based entirely, or in part, on the request data and/or forecasts.

Before describing the invention in more detail, a more detailed description of one embodiment of RDCS 102 is provided for background information.

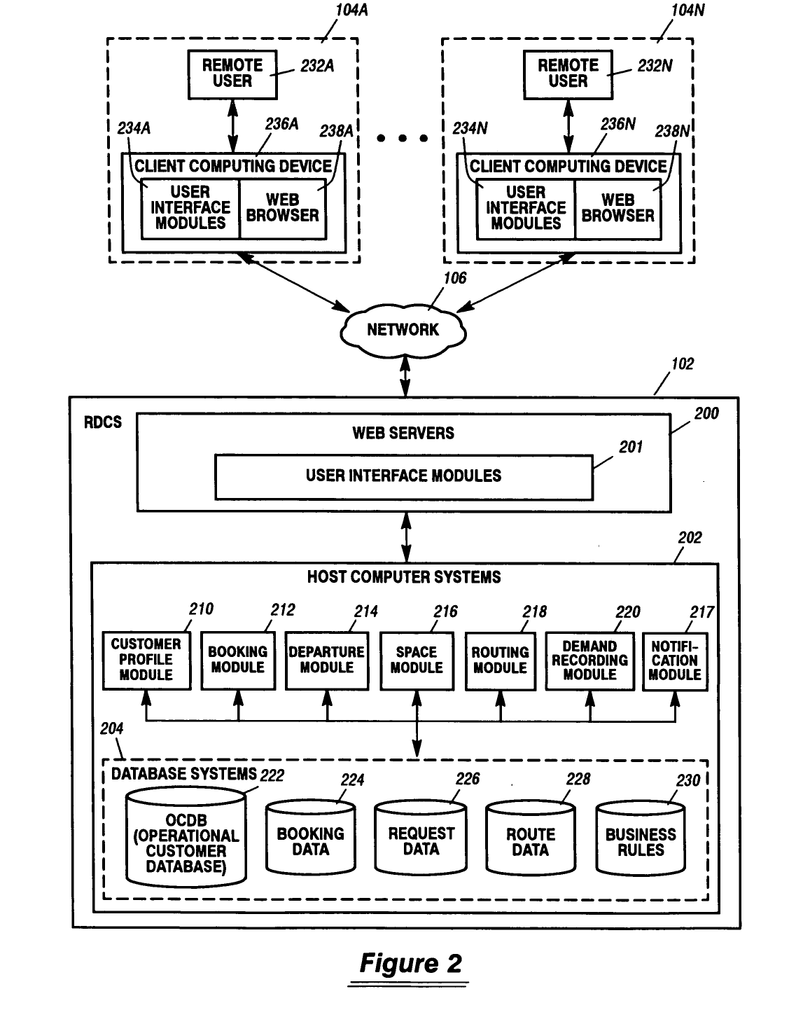

FIG. 2 is a block diagram illustrating an exemplary embodiment of RDCS 102 in further detail. In the exemplary embodiment, RDCS 102 includes one or more web servers 200 coupled to host computer systems 202. Host computer systems 202 may include one or more servers executing the Unix, Linux, Windows®, or any other operating system. Host computer systems 202 provide database systems 204 for storing data. Example database systems include SQL Server from Microsoft Corporation and the Oracle database from Oracle Corporation. Although illustrated separately, web servers 200 and host computer systems 202 may be integrated, and/or provided by one or more computing systems.

In general, RDCS 102 provides a computing platform for hosting management services for one or more airline carriers. In one embodiment, RDCS 102 provides network-based management of customer data stored in Operational Customer Database (OCDB) 222. OCDB 222 provides a centralized repository for maintaining consistent, current customer data for use by any of the service modules executed by host computer systems for various tasks such as performing demand tracking activities.

Host computer systems 202 execute software service modules 210-220. These service modules generally represent software modules having executable instructions to assist airline personnel in providing airline services. In this example, host computer systems 202 execute a customer profile module 210, a booking module 212, a departure module 214, a space module 216, a routing module 218, a demand recording module 220, and a notification module 217.

Customer profile module 210 allows a remote user to create, retrieve, and update OCDB 222. OCDB 222 is accessible by each of modules 210-220 and stores all information about a customer including preferences regarding seat assignments, meals, connection points, hotels, vehicle rentals, and so on. OCDB 222 may also store contact information, travel plans, special customer needs and requirements, history information including any disservice the customer may have experienced in the past and any resulting compensation, and other information. In addition, OCDB 222 includes primary or basic customer data such as name, address or other customer information.

Customer profile module 210 may also populate OCDB 222 with links to biometric information maintained in an external database. In some embodiments, OCDB 222 may be embodied by, or coupled to, a Customer Loyalty System (CLS) commercially available from Unisys Corporation that handles processing of frequent flier information.

Turning next to booking module 212, this module receives and manages the booking data associated with airline flights. Booking data is defined as all of the information about a passenger or a group of passengers that are traveling together on the same journey. Such information, sometimes referred to simply as “a booking”, includes passenger names, the number of segments in the journey, the flight routes included within the journey, and any special requirements such as special meals, wheelchairs, etc. that may be needed by one or more of the members in the party. It may further include car rental and hotel information, the manner in which the passengers are being ticketed, data regarding travel documents, contact and payment information, and information regarding any other accommodation or service associated with the journey. This data is stored as booking data 224 within database systems 204.

Departure module 214 manages the check-in process on the day of departure, including the check-in of passengers and baggage. For example, remote user 232A may interact with departure module 214 to obtain the issuance of boarding passes and bag tags, and to manage standby passengers. In addition, a remote user 232 may indicate any special needs and requests required by passengers.

Space module 216 manages information regarding the space that is available on flights provided by the current carrier. For instance, this module controls sales restrictions for flights. This module may be coupled to an external space module (not shown), which provides information on space available on flights provided by other carriers. Another related module, seats module 220, provides information on the layout of each aircraft, including information concerning the seating configurations.

A flight module (not shown in FIG. 2) may be provided to define the flights that are hosted by the airline. For example, this module may determine the times and dates that flights will be provided from the various airports serviced by the airline. This flight module stores departure and arrival flight times and locations, the aircraft assigned to a given flight segment, information on fare classes, and information regarding the classes of service provided by a flight. This information may be stored as route data 228.

Route data 228 is available to routing module 218. Routing module 218 utilizes route data 228 to determine the various route options that are available to customers. For example, routing module will determine the best way for a customer to travel from a desired departure location to destination point using the flights generated by flight module.

According to the current invention, demand recording module 220 is provided to selectively capture requests submitted by potential customers soliciting information on the availability of routes (i.e., “availability requests”) for use in tracking flight demand and analyzing profitability of the carrier. This module is also capable of storing all booking requests that are issued in attempt to book one or more seats on a flight. The captured booking requests may include those requests that do not result in the creation of a booking because the requested flight is full. This module will be discussed in detail below.

FIG. 2 also includes notification module 217, which may be used to generate automated notifications according to one aspect of the invention. This will be described below.

Host computer systems 202 may include other service modules (not shown) that are coupled to OCDB 222, including a ticketing module for managing ticket activity, a module for seat allocation, assignment, and reseating processes, an information module for managing automated information such as visa requirements, ticketing rules, luggage policies and procedures, fare rules, promotions and the like, an agreement module to store agreements that exist between an airline and its partners, and a load control module for assisting airline load control agents to plan the distribution of payload aboard an aircraft.

Web servers 200 provide a seamless interface by which remote users 232A-232N or local users (not shown) may access host computer systems 202. Although host computer systems 202 and web servers 200 are illustrated separately in FIG. 2 for exemplary purposes, RDCS 102 may be realized by a single computing device or a plurality of cooperating computing devices such as a clustered computing architecture.

According to the exemplary illustrated embodiment, web servers 200 provide a web-based interface by which authorized remote users 232A-232N communicate with RDCS 102 via network 106. In one configuration, web servers 200 execute web server software, such as software marketed by Microsoft Corporation under the trade designation “INTERNET INFORMATION SERVER.” As such, web servers 200 provide an environment for executing user interface modules 201. User interface modules 201 provide an interface that allows users 232A-232N to manage airline reservations, check-in, and re-booking functions. User interface modules 201 may include Active Server Pages, web pages written in hypertext markup language (HTML) or dynamic HTML, Active X modules, Java scripts, Java Applets, Distributed Component Object Modules (DCOM), and the like.

User interface modules 201 may execute within an operating environment provided by web servers 200. Alternatively, portions of user interface modules 201 may be downloaded as “client-side” user interface modules 234A-234N that are executed on client computing devices 236A-236N, respectively. Client-side user interface modules 234A-234N could, for example, include Active X components or Java scripts executed by web browsers 238A-238N executing on client computing devices 236A-236N respectively.

It will be understood that the RDCS shown in FIG. 2 is exemplary only. Other systems may include fewer or more modules, may omit or add functionality, and/or may implement similar functionality in alternative ways. Thus, FIG. 2 should be considered as only one of many types of systems that may usefully employ the current invention.

As previously described, prior art RDCS systems only capture information regarding requests for flights that actually result in the booking of seats by booking module 212. This results in the loss of a large amount of valuable data that can be used to maximize profitability of the carrier. The current invention captures data associated with all, or a selected portion of all, of the requests that do not result in the booking of a flight. This includes availability requests, as well as booking requests that do not result in the sale of one or more seats. This captured request information may be stored within database systems 204 as request data 226. In one embodiment, this data may be captured by a dedicated demand recording module 220 as shown in FIG. 2. In another embodiment, the logic to capture the requests may be contained within another one of the modules, such as space module 216.

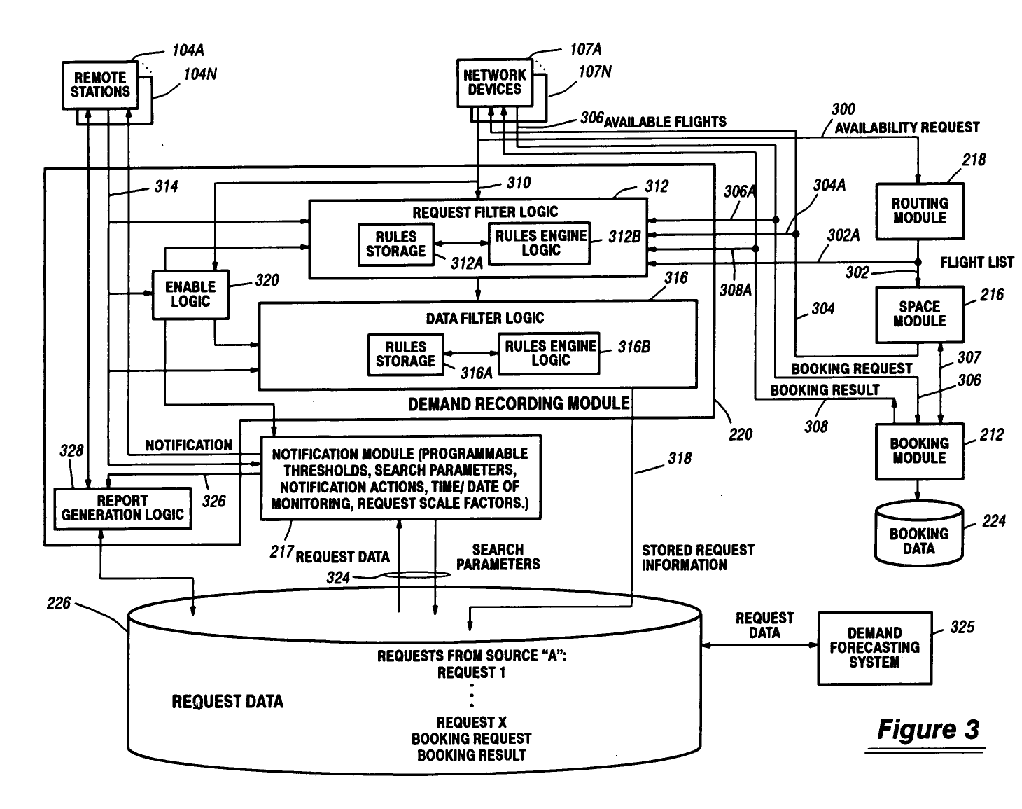

FIG. 3 is a block diagram of one embodiment of demand recording module 220 and related modules according to the current invention. Before discussing the demand recording module 220 in detail, a general overview is provided regarding an exemplary method of handling availability requests and booking requests. Merely for discussion purposes, this method of handling requests is described in terms of the modules existing within illustrative RDCS 102 of FIG. 2. However, as previously mentioned, many different types of alternative RDCS systems exist that may provide similar or different functions, have more or fewer modules, and that may handle booking and availability requests in a different manner. Thus, it will be understood that the method of handling availability and booking requests as described in the following paragraphs is only one of very many alternative methods, and is provided solely for background purposes, and to facilitate a better understanding of the description of the invention that follows.

Availability requests are shown being received from users of network devices 107A-107N. Such requests are making inquiries pertaining to the availability of one or more flights.

Availability requests may be received from a wide array of sources. For instance, such requests may originate from an on-line travel agency such as the Obitz.com web site. These requests may also be submitted via a global distribution system (GDS) of the type used by travel agencies to determine availability of flights. Such GDSes include Saber, Worldspan, Amadeus, and so on. In yet another embodiment, the requests may originate from another RDCS that is hosting a different airline. In one embodiment, availability requests are not only submitted via network devices 107, but are also issued by users at remote stations 104 who may be employed as booking agents, for instance. For ease of reference, only those availability requests submitted by network devices 107 will be discussed, however it will be understood that this discussion applies equally to any availability requests received by RDCS 102, including those submitted via remote stations 104.

Availability requests generally include such information as a desired departure time/date/location, as well as a destination location. The requests will generally also specify a desired airplane “compartment”, such as a first-class, business-class, or coach compartment. Availability requests received from outside of the RDCS 102 (that is, from other than a booking agent located at remote stations 104) will also typically include a flight number. That flight number is obtained from local flight information stored by the entity that issued the request. For instance, a travel agency or an on-line travel web site may locally store information describing the flights provided by one or more airlines. This information may become outdated over time, and thus an availability request may be issued by the travel agency or web site to RDCS 102 to determine whether one or more specified flights are still available to satisfy the desired travel plans of a customer.

Availability requests may also include customer information such as a name, a frequent-flier number, and/or other customer identification. Other information that may be received by RDCS 102 along with the request includes the origin of the request, such as a location (e.g., city, country, and continent) and/or the name of the web site from which the request was issued. The type of origin information (also referred to as “point-of-sale”, or POS information), that is provided with the request will generally vary depending on whether the request was issued via a GDS, the Internet, a booking agent of the airline, and so on.

The request information may also specify whether the request is being issued by schedule or price. In other words, the request will indicate whether the requested departure time is more important than ticket price, or vice versa, as determined by information provided by the customer.

As may be appreciated from the foregoing, many different types of information may be provided with an availability request. Such information may include, but is not limited to, the source of the request (e.g., web site, travel agent, etc.), the time and/or date on which the request was issued, the type of request (e.g., issued by price or schedule), the origin and destination of travel, requested time and date of travel, and one or more flight numbers (as provided with those requests that originate from sources other than the airline's booking agents, for instance). Other information provided with availability requests may include a compartment (e.g., first-class, business-class, etc.), and customer information (e.g., name, frequent flier information, customer identification numbers, etc.).

The availability requests are providing to routing module 218 on line 300. Routing module 218 will select one or more of the existing routes that may potentially satisfy the customer's request. These routes will generally be selected based on the origin and destination information for the request, as well as the specified departure time. The most preferential routes will generally be those that contain a single flight that directly services the requested origin and destination locations, and that departs the closest to the requested departure time. Other less desirable routes may include multiple flights or flight segments such that a customer traveling on the route may have to change planes and/or experience a delay at an intermediate stopping point. The number of possible options retrieved by routing module 218 for a given request may be a programmable operating parameter of the system that is selected by an authorized airline employee.

After routing module 218 determines a list of routes that may potentially satisfy the customer's request, fare information is retrieved for these routes. This information may be obtained by making a request to a fare module (not shown), for instance.

Next, this list of flight options, the fare information, and information regarding the availability request are provided by routing module 218 on line 302 to space module 216. Space module then determines which flight and/or flight combinations are considered available, meaning the flights include enough seats to satisfy the availability request. This may further involve determining whether available seats reside within the particular compartment specified by the request. The list of available flights that will satisfy the request, and the fares assigned to each of these flights, is returned to the requester, as represented by line 304.

The process of submitting an availability request and receiving the results may be repeated any number of times. If the customer finally determines that one of the returned flights or flight combinations will satisfy his/her requirements, a booking request may be submitted on line 306 to booking module 212 to actually purchase one or more seats.

A booking request will generally specify a particular flight number identifying a flight. A booking request also generally includes the price of a seat. This price maps to a booking class. As is known in the art, booking classes are used to control availability of seats at predetermined prices. For instance, a promotional deal may be offered whereby a limited number of seats are being sold at a discounted price. To control the number of seats sold at this price, these seats are mapped to a booking class. The booking class is then generally associated with a compartment (e.g., first class, coach, etc.) and the number of seats available at the discount price. An airline may define many booking classes for the same compartment. For instance, the coach compartment of an aircraft may be divided into booking classes such as the “Q”, “B”, and “M” classes.

As may be appreciated by the foregoing, since a booking request will generally include pricing information, and since pricing information maps to a booking class which, in turn, is associated with a compartment, a booking request is associated with both a booking class and compartment. This booking request will also usually include customer information such as passenger names and any frequent flier information. A booking request may further include other identifying indicia such as address, phone, and other contact data for the customers. Additional request information may indicate whether the booking request is associated with any special needs (e.g., wheel chair request, unaccompanied minor, and so on.)

When booking module 212 receives the booking request, a determination is made as to whether the requested seats on the requested flight are still available for purchase. In one embodiment, booking module makes this determination by making a request to space module 216 via interface 307. Space module 216 responds by indicating whether space is available such that the request may be completed. If space is available, booking module ensures that the purchased number of seats are reserved for the given request, although the actual seat assignment will generally not occur at this time. In addition, space module 216 decrements the number of available seats in the appropriate compartment of the flight by the purchased number of seats, and returns a response to the customer on line 308 indicating that the booking has been completed successfully.

While the booking is being completed, booking module 212 stores information describing this booking to booking data 224. The stored information includes data concerning the passengers for this booking, including passenger names, addresses, any seating preferences or assignments, frequent flier information, payment information, and so on.

As noted above, the foregoing discussion provides one of many exemplary methods for handling booking and availability requests by an RDCS, and is provided for background purposes only. It will be understood that the invention, which is to be described in detail in the following paragraphs, may be used by any RDCS, regardless of whether that RDCS handles booking and availability requests using different modules and/or methods.

In prior art systems, booking data 224 is used for performing demand forecasting. For example, this data may be used to determine how quickly a particular flight became overbooked. This information may then be extrapolated to predict what type of demand existed for that flight. These types of forecasts do not take into account availability requests, and do not take into account booking requests that could not be satisfied.

According to the current invention, demand tracking is improved by recording all, or a selectable portion of all, availability requests. Further, the system may also selectively record some or all of the booking requests that did not result in a booking. The captured request data may then be provided as input (e.g., as a data file) to a demand forecasting system 325 that may determine, for instance, whether flights must be added or cancelled, whether equipment should be changed for one or more flights, whether flight schedules should be altered, and so on, to meet the recorded demand. The manner in which demand forecasting system 325 analyzes the data is largely beyond the scope of the current invention.

According to one embodiment, all availability and booking requests are provided on lines 310 and 306A, respectively, to request filter logic 312 of demand recording module 220. In one embodiment, request filter logic 312 is configured based on programmable settings provided by airline employees via interface 314 from remote stations 104A-104N. These settings select certain types of the availability and booking requests that are to be stored to request data 226.

In one embodiment, the programmable settings used to configure request filter logic 312 are provided in the form of programmable business rules defined by authorized airline personnel. For instance, an inventory control agent of the airline may determine that a study is to be performed to analyze demand for flights from Minneapolis to Madison or Milwaukee that are traveling over the Thanksgiving weekend, from November 23-27. To accomplish this, the inventory control agent defines programmable business rules that select the desired types of requests. These rules are interpreted by request filter logic 312 to cause the selected types of requests to be stored as request data 226.

In one embodiment, the programmable business rules may be defined by an agent located at one of remote stations 104 and provided directly to request filter logic 312 via interface 314. In another embodiment, these rules may be stored to database systems 204, where they are retained as business rules 230 for later retrieval and use by request filter logic 312.

In general, the programmable rules that determine the types of availability requests to be captured may reference any of the data items provided with the availability requests. For instance, as noted above, availability requests may include, without limitation, the source of the request (e.g., web site, travel agent, etc.), the time and/or date on which the request was issued, the type of request (whether it was issued by price or schedule), the origin and destination of travel, requested time and date of travel, one or more flight numbers, a requested compartment, and customer information. The programmable rules may reference any one or more of these types of information to select the availability requests to be captured. The referenced data items may be interrelated via Boolean logic (e.g., AND, OR, NOT).

As may be appreciated, a virtually limitless number of programmable business rules may be written to select the availability requests that are to be captured. As one example, a programmable rule may be defined to capture all availability requests that originate from the “Orbitz.com” website that are requesting availability of seats in the first-class compartment on flights from Minneapolis to Washington D.C.

Request filter logic 312 also receives booking requests, as discussed above. These requests are provided to request filter logic 312 via interface 306A. Programmable rules may be defined to select the types of these requests to be captured and stored within request data 226.

Booking requests may include, without limitation, the source of the request (e.g., web site, travel agent, etc.), the time and/or date on which the request was issued, a price specified with the request, the origin and destination of travel, requested time and date of travel, and customer information. By virtue of the specified price, the booking request will also be associated with a compartment and a booking class.

A booking request may further be associated with a status. For instance, booking module 212 may provide information to demand recording module 220 on interface 308A to indicate whether the booking request was honored. This information may indicate, for instance, that the requested flight was full and the request could not be completed. Alternatively, this information may indicate that the manner in which the request was booked. For instance, the status information may indicate the request was completed, and the passengers were upgraded because of some inconvenience experienced by those passengers when traveling on the airline in the past.

As is the case with availability requests, the programmable rules that are defined to select booking requests may reference any one or more of the types of information associated with booking requests. For instance, a programmable rule may be defined to capture all booking requests that originate from the Orbitz.com website that do not result in a booking, as indicated by the request origin information and the booking status, respectively.

In addition to receiving the booking and availability requests, in one embodiment, request filter logic 312 further receives the flight list generated by routing module 218 on line 302A. Recall that this list includes a list of N flights that would best satisfy the request, wherein N may be programmable. These flights, which may, or may not be, available, provide the list of “best fit” flights for the request.

Request filter logic 312 may further receive the list of flights that are available to satisfy the request based on the requested number of seats, the type of seats requested (e.g., first class, coach, etc.), and so on. This list, which is generated by space module 216, is a subset of the list provided to request filter logic 312 by routing module on line 302A.

Request filter logic 312 may include a storage facility shown as rules storage 312A to store the rules that will determine which availability and booking requests will be captured. In one embodiment, this logic further includes a rules engine 312B, which is logic that is capable of interpreting various programmable business rules as is known in the art. The JRules rules engine commercially available from hog Incorporated may be employed for this purpose. Many other rules engines are commercially available in the alternative. In yet another embodiment, rules engine 312B may be replaced by table-driven logic, as is discussed further below.

If request filter logic 312, through the use of rules engine 312B, determines that an availability or a booking request is described by the definition of one of the programmable rules such that the request should be saved to request data 226, request filter logic 312 provides all of the information for that request to data filter logic 316. The information that is so provided may include, but is not limited to, any of the types of availability or booking request data items that are listed above. In one embodiment, the provided information further includes the flights list provided by routing module 218 and the available flights list provided by space module 216 for an availability request. For a booking request, this information may also include the booking status that indicates whether/how a booking was completed by booking module 212.

Like request filter logic 312, data filter logic 316 is programmable via settings selected by employees of the airline. Such setting may be provided as programmable business rules supplied directly via interface 314, or retrieved from database systems 204. This logic may include a storage facility shown as rules storage 316A which stores applicable data filter rules. This logic may further include a rules engine 316B to interpret these rules.

The rules utilized by data filed logic 316 determine which information will be saved to request data 226 for a given request that is to be captured. For instance, the rules may determine that for a given availability request that has been selected for capture by data filter logic 312, information will only be saved that describes the origin and time of the request, the requested departure time/date/location, the requested destination, a list of the flights provided by routing module 218, and the status indicating which of these flights were full at the time of the request. By limiting the request information in this manner, the time required to search and process the data will be minimized, and the amount of storage space consumed by the data will be reduced. In a default situation wherein no rules are defined, all data provided by request filter logic 312 to data filter logic 316 for a predetermined request is saved to request data 226.

As noted above, in one embodiment, request filter logic 312 and data filter logic 316 each includes storage space to store the rules that are to be interpreted by the respective logic. Further, each of these logic sections includes respective rules engine logic to perform interpretation of the corresponding rules. In an alternative embodiment, a central rules engine is provided within demand recording module 220 to interpret both the request filtering and data filtering rules. In yet another embodiment, the rules engine logic may be implemented as a centralized module to interpret rules on behalf of multiple ones of the modules shown in FIG. 2.

Request data 226 may be organized in many different ways. According to one embodiment, all requests from a given origin such as a particular web site are stored together in a time order. Utilizing this format, an analysis may be readily conducted to determine the services that were originally requested by an availability request, as well as whether any associated booking request resulted in a booking to something other than those desired services. This may have been necessary, for instance, because of flight unavailability. Alternatively, the stored request sequence may indicate that the customer likely did not find a suitable flight, and thus a sale was lost.

According to another aspect of the invention, interface 314 from remote stations 104A-104N is further communicatively coupled to enable logic 320. Like request filter logic 312 and data filter logic 316, enable logic may include both a local storage facility to store enabling/disabling rules, and may include logic to interpret those rules. According to the alternative embodiment discussed above, enable logic 320 only stores the enabling and disabling rules, and a centralized rules engine included either within demand recording module 220 or elsewhere within RDCS 102 is utilized to interpret those rules.

Regardless of the embodiment, the rules maintained by enable logic 320 are defined to recognize selected trigger events that will enable and disable the use of request filter logic 312 and data filter logic 316. When both request filter logic 312 and data filter logic 316 are disabled, the storing of request information to request data 226 is not occurring. However, when an enabling trigger event occurs to enable the request filter logic 312 and data filter logic 316, selection of requests and filtering of data is initiated in the above-described manner.

An enabling event may be a date/time combination, for instance. For instance, storing of requests may be enabled on October 31 at midnight. Alternatively, an enabling event may be the occurrence of a predetermined request rate on interfaces 310 and/or 306A. For example, the storing of availability requests may be triggered when the number of such requests issued from a predetermined source or location (e.g., travel agency X in Miami) exceeds a predetermined number in a predetermined time period on interface 310. This triggering event may be further identified using additional request information. For instance, only requests that are originating from a particular location and that are requesting seats in the first-class compartment may be selected to count towards the triggering event. Any other type of measurable event may be used to automatically enable or disable request filter logic 312 and data filter logic 316.

If desired, request filter logic 312 and data filter logic 316 may be enabled or disable individually using programmable rules. If request filter logic 312 is enabled, but data filter logic 316 is not, all information for the selected requests is stored to request data 226. Conversely, if request filter logic 312 is disabled, but data filter logic is enabled, the selected information for all requests is stored as request data.

The foregoing discussion relates to defining programmable business rules to control enable logic 320. In still another embodiment, request filter logic 312 and data filter logic 316 may be enable or disabled manually by authorized personnel via interface 314 using the appropriate commands that are issued to enable logic 320.

As discussed above, request data 226 is utilized to perform demand forecasting. Selected portions, or all, of the request data is provided to a demand forecasting system 325 as a data file or in some other format. Demand forecasting system analyzes this data to determine any mismatches between the indicated demand and the services provided by the airline. For instance, demand forecasting system 325 may determine that more flights must be added to service certain cities on a permanent, or a temporary, basis. Demand forecasting system 325 may further determine that other flights should be cancelled because of lack of demand. The aircraft used to service certain routes may be changed so that the number of seats available more closely meets demand. The manner in which this forecasting is performed is largely beyond the scope of the current invention.

Demand forecasting system 325 may perform calculations using the request data. For example, calculations may be performed to determine an estimated amount of lost revenue that occurred because of a mismatch between demand and the number of seats provided by the airline. This analysis can be performed in a much more accurate manner when using the request data provided by the current system and method than when utilizing prior art booking data. As discussed above, the booking data captured by prior art systems can, at most, indicate a situation wherein one or more flights are consistently overbooked. However, this booking data does not in any way reflect “lost demand”, which is the demand that was essentially lost because a booking request could not be satisfied or because an availability request resulted in the return of only unsatisfactory flights.

While the capturing of request data 226 is performed primarily for use by forecasting logic in the above described manner, it may be used for other purposes as well. For instance, in one embodiment, this data may optionally be made available to a notification module 217 and/or report generation logic 328.

Notification module 217 may optionally be provided to monitor request data 226 and to automatically generate notifications based on that data. Notification module 217 may be configured via interface 314 using programmable settings, which may be in the form of programmable business rules similar to those discussed above. The programmable settings determine which request data should be monitored, as well as the manner in which the notifications should be generated.

Notification module 217 may monitor request data 226 continually while new availability and booking request data is being stored, or may instead initiate searching after collection of data has been disabled. Alternatively, searching may be initiated following the occurrence of a particular trigger event or at a particular time of day in a manner similar to that described above.

In one embodiment, notification module monitors the number of requests of a selected type for which data is stored within request data 226. Notification module 217 initiates specific actions when this number reaches a programmable threshold. For instance, notification module 217 may be programmed to monitor the number of requests that are being stored within request data 226 for first-class seats on flights from Minneapolis to Madison on November 23. Notification module 217 may be programmed to send a notification if the request levels exceed a selected number of requests per hour. Such a notification may include an email issued to one or more authorized employees located at one or more of the remote stations 104A-104N. A notification might also consist of an automatically-generated phone call, the issuance of some type of written notice, or any other type of indication that the triggering threshold has occurred.

In one embodiment, notification module 217 sends a message on interface 326 to report generation logic 328, causing that logic to generate a report containing information regarding one or more of the request types being tracked by notification module 217. This report can be transferred to an authorized employee automatically, if desired. For instance, a report may be provided as an email attachment along with a notification that a request threshold has been reached or exceeded.

One or more selected request thresholds may be tracked by notification module 217 at a given time, if desired. Notification module 217 may be programmed to associate each of these thresholds with a respectively different notification event, if desired. An inventory control agent employed by the carrier may utilize this notification, for example, to determine whether demand for a given flight warrants temporarily or permanently adding another flight servicing the origin and destination points. This might be warranted, for instance, during peak holiday or vacation travel periods. In another scenario, request data may indicate that flight demand warrants changing the fee model for a flight, as might involve eliminating one or more inexpensive booking classes and increasing the number of more expensive fares. This will increase the profit margin of the flight.

The current system and method are of particular importance for identifying any unusual demand for one or more flights as indicated by very high request levels. For instance, an airline servicing a particular city may have inadvertently overlooked an upcoming business convention that warrants the temporary addition of more flights into, and out of, that city. The type of demand tracking system described herein may be programmed so that unusual request activity will be brought to the attention of the appropriate personnel. This allows such situations to be addressed in a timely manner without the forfeiture of revenue.

Notification module 217 is able to monitor requests based on programmable setting, as discussed above. In one embodiment, this monitoring of request data is controlled via programmable rules. Such rules may reference any of the request data and may utilize Boolean logic in the manner described above. For instance, a rule may be defined to cause notification module 217 to monitor a specific type of availability request that originates from one or more selected web sites or locations. For example, this would allow availability requests originating from travel agents or that are placed with the airline's booking agents to be monitored, while all other requests from other sources (e.g., a customer's home computer) may be excluded. This type of selective request monitoring may be desirable because the former types of requests may represent those customers that are more intent on making a purchase as compared to potential clients that are merely browsing via their personal computer.

Like notification module 217, report generation logic 328 may access request data 226 to generate selected reports under the control of commands issued by authorized personnel from remote stations 104. Alternatively, such reports may be generated based on programmable business rules. For example, a rule may be defined to cause reports generation logic 328 to generate predetermined reports at known time intervals. Additionally, reports may be generated based on messages received from notification module 217, as described above.

It may be appreciated that the system of FIG. 3 is exemplary only, and many other embodiments of this logic are possible within the scope of the current invention. For instance, in some embodiments, the logic of FIG. 3 need not be programmable such that request filter logic 312, data filter logic 316, and notification module 217 are “hard-coded” to store and/or retrieve certain predetermined types of requests and information. Alternatively some of this logic may be omitted entirely. For instance, if all request data is always stored, data filter logic 316 may be omitted. Likewise, if data for all availability and booking requests are always stored, request filter logic 312 may be omitted. As another example, a centralized rules engine that interprets the request filter, data filter, and enabling/disabling rules may be provided rather than utilizing specialized rules engine logic for each logic section. Alternatively, a rules engine may be provided that interprets other types of rules for one or more other modules of FIG. 2.

In general, the various logic sections included within demand recording module 220 are implemented in software, firmware, microcode, or some combination thereof. However, some of these logic sections may alternatively be implemented partially or entirely in hardware.

In one alternative embodiment, rules storage 312A, 316A and rules engine logic 312B, 316B may be replaced by tables. For instance, a table may be defined to include all of the attributes that may be used to define a type of availability request (e.g., request origin, request time and date, requested flights, etc.) The table includes an entry for each potential combination of the attributes. Each entry specifies the “rules” for that combination. For instance, the entry may store data describing if, and how, the corresponding type of availability request will be saved. The logic (e.g., the software) consults the appropriate table entry to determine how processing should proceed. This type of table-driven approach has the advantage of not requiring the use of a specialized rules engine. However, it does not provide the flexibility afforded by a rules engine to allow new attributes and logic to be added dynamically within the system.

The functionality shown in FIG. 3 may be included in a dedicated demand recording module as shown, or may instead reside within one or more other modules that are similar to, or different from, the types of modules that are shown in FIG. 2. For example, some or all of the illustrated logic may reside within space module 216. Alternatively, the logic included in demand recording module 220 may reside in multiple dedicated modules, such as a report generation module, a monitoring module, and a request capture module.

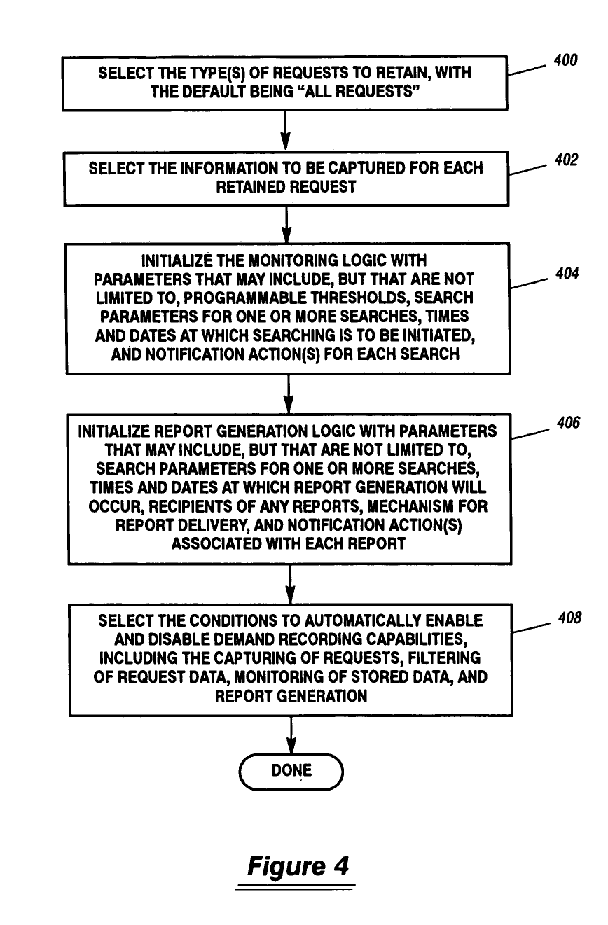

FIG. 4 is a flow diagram illustrating one method of initializing the various capabilities of demand recording module 220. One or more types of requests are selected as those to retain (400). In a default situation, all availability and booking requests are retained. In one embodiment, selection of the requests to be captured is accomplished by programming request filter logic 312 with programmable setting that may include any of the availability and/or booking request data listed above. This includes, but is not limited to, origin and time of the request, origin and destination of travel, requested departure time and date, any requested compartment, whether the request specifies price or schedule, whether a booking request resulted in a booking, and any other information provided with the request, such as whether a request solicits travel on a particular type of aircraft (e.g., equivalent of a 727 or larger.)

In addition to specifying the types of requests to capture, a user may also indicate the types of information to be stored for each of the requests that will be captured (402). Such information may include any, or all, of the request attributes described in the foregoing paragraph. Additional information may include a list of N routes that would satisfy the request if the routes were available, and a list of M available routes that are available to satisfy the request.

Notification module 217 may also be initialized to monitor the request data (404). The parameters used to initialize this logic may include, but are not limited to, programmable thresholds that determine a rate at which certain request types are being received, search parameters for one or more request searches, times and dates at which searching will be initiated, and any notification or report-generation actions that will be taken if a given threshold is determined to have been reached.

Similarly, report generation logic 328 may be initialized with parameters that will initiate searching and/or generation of selected reports (406). These parameters include, but are not limited to, search parameters to initiate one or more searches, times and dates at which report generation will automatically be initiated, the recipients of the generated reports, the mechanisms for delivering those reports (e.g., email attachments, hardcopies, files stored to a predetermined directory within a directory structure, automatically faxed copies, etc.). Any notification mechanisms that are being used to deliver the reports may further be programmed (e.g., an automatic email or phone message that indicates availability of a report, and mechanism(s) for obtaining a copy of that report.)

Finally, any conditions that will be used to trigger the enabling and/or disabling of tracking capabilities are selected (408). This may include defining the trigger events that enable and/or disable request filter logic 312, data filter logic 316, notification module 217, and/or report generation logic 328. This step may involve programming the respective parameters in each of the respective logic sections, or may instead involve programming centralized control logic such as enable logic 320. In one embodiment, enable logic 320 determines when any trigger event has occurred and then enables the logic section associated with that trigger event.

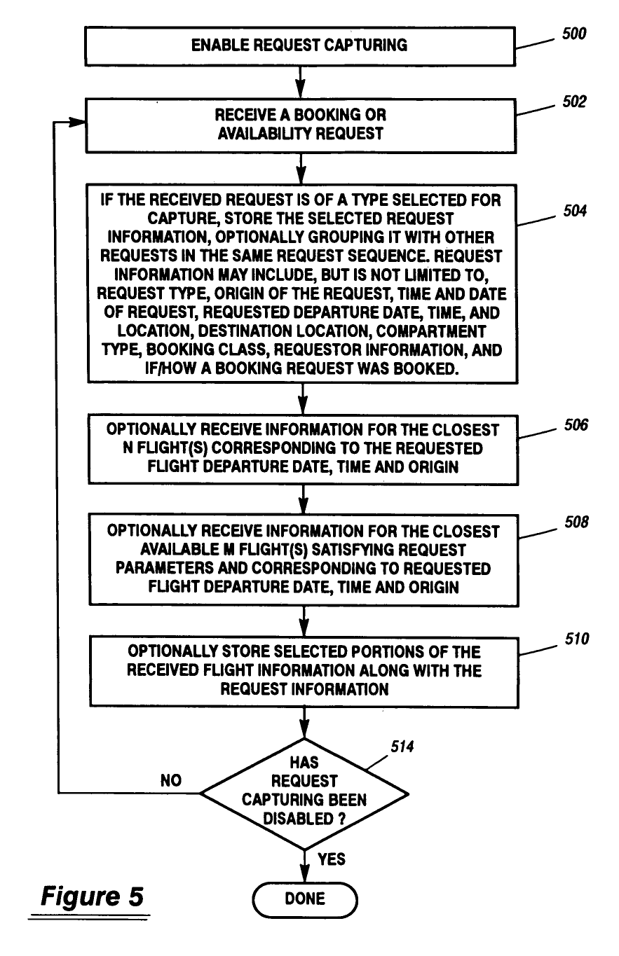

FIG. 5 is a flow diagram illustrating the capturing of requests according to one embodiment of the invention. First, the capturing of requests is enabled (500). Thereafter, a booking or availability request is received (502). If the received request is of a type that is selected for capture, as may be determined by request filter logic 312, selected information is stored for that request (504). Optionally, this request is grouped with other requests in a same request sequence that originated from the same request source (e.g., from the same travel agency GDS). This may be determined by the origin of the request, for instance. Stored information may include, but is not limited to, the origin of the request, the time and date the request was made, a requested departure date, departure time, departure location, the requested destination, any requested compartment or service type (e.g., first class or coach), any requester information (e.g., name, address, frequent flier id), any booking class, and request type information (e.g., whether the request was submitted by price or schedule).

Additional information may be received for this request, such as the N flights that would best satisfy the request, assuming all flights are available (506). In one embodiment, this list of “best-fit” flights may be received from routing module 218. Additional information such as a list of the M available flights that might best accommodate the request is received (508). In one embodiment, this information is received from space module 216.

Optionally, a selected portion of the “best-fit” and the available flight information may be stored along with the request information (510). If request capturing has not yet been disabled (514), processing continues to step 502 where another request may be received. Otherwise, processing is considered complete until request capturing is again enabled.

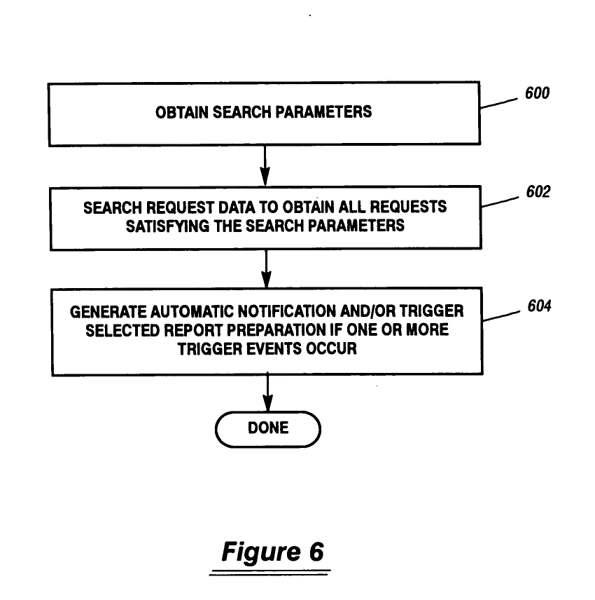

FIG. 6 is a flow diagram illustrating the use of notification module 217. First, notification module is initialized with search parameters that may include, but are not limited to, programmable thresholds, search parameters, times and dates at which searching is to be initiated, and notification actions for each search (600). This step may be accomplished during initialization of demand recording module 220, as shown in FIG. 4. The notification module may alternatively be initialized later, and thereafter re-initialized as needed.

Notification module 217 initiates one or more searches for the request data that satisfies the search parameters (602). If one or more thresholds are reached (e.g., a predetermined number of requests of a particular type was received in a predetermined time period), automatic notification actions may be triggered (604). These types of actions, which may be programmably selected, may include notifying certain authorized employees, and/or prompting the generation of one or more corresponding reports. These reports may be automatically routed to the appropriate personnel as part of the notification process.

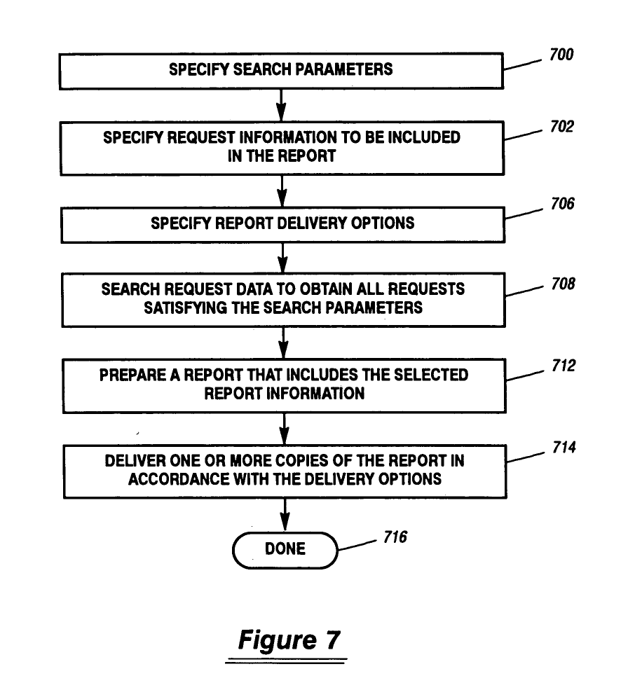

FIG. 7 is a flow diagram of a method of managing report generation according to one embodiment of the invention. Programmable settings and search parameters are provided by an authorized employee such as an inventory management agent to the report generation logic 328. This may be accomplished during initialization of the demand recording module 220, or at any time thereafter (700). The search parameters are used to search request data 226 for the availability and booking requests of interest. In addition, a user specifies the desired information that is to be included within a report (702). For instance, the user may indicate that the date and origin of the request itself, as well as the origin, destination, and time of the requested flight, are to be included within the report along with the best-fit flight (regardless of whether it was available). The report may further indicate whether a booking resulted from this request. Alternatively, rather than selecting the data to include in a report in this manner, pre-defined reports may be available such that the user selects a report rather than specifying the data to be included in the report.

Finally, report delivery options may be specified by the user (706). This may include, for instance, a list of email addresses that are to receive a copy of the report as an attachment.

Next, a search is initiated on request data 226 for the availability and/or booking requests that satisfy the search parameters (708). This request data is returned to report generation logic 328. A report is prepared that includes the desired information (712). This information may be provided to one or more authorized agents in accordance with the selected delivery options (714).

As discussed above, various types of trigger events may prompt generation of notifications and/or reports. For instance, it may be important to note whether a very large number of requests for flights are being submitted directly to booking agents of the carrier between noon and one o'clock on week days. This may not only aid in tracking flights, but could also be useful in determining the amount of demand that will be placed on data processing systems that will be supporting and handling these in-coming requests. This type of information may be used to ensure that all requests are handled in a timely manner so that customers are not, for instance, aborting the requests because they are kept waiting an unacceptable amount of time.

It may also be desirable to generate reports that describe look-to-book ratios for various types of shopping forums. For example, it may be helpful for an airline to know how many total requests for a given flight are made from a particular web site, and how many of these requests actually result in the sale of one or more seats. This information can be used to determine the look-to-book ratio associated with that flight on the web site. Similar information may be accumulated for all requests made from the web site for any flight. This information may be used to determine the effectiveness of the web site as a sales tool, for instance. Other similar types of determinations may be made using the availability request and booking data.

As is discussed above, the various logic sections of demand recording module 220 may be programmable. The programming options may be expressed as programmable business rules. For instance, the following English-version representation of a programmable rule may be provided to request filter logic 312 to cause that logic to select all availability requests that are requesting flights traveling from Minneapolis to Madison or Milwaukee at any time from November 23 through November 27:
Select (Requests1):
   Request_type=Availability AND
   Depart_date=November 23-27 AND
   Origin=Minneapolis AND
   Destination=Madison OR Milwaukee

This rule indicates that all availability requests that specify a departure date between November 23-27, and which are requesting departure from Minneapolis and arrival in Madison or Milwaukee will be selected. This rule assumes that “Request_type”, “Depart_date”, “Origin”, and “Destination” are valid fields that have been defined for request data 226, and that the specified values for these fields (e.g., “Availability”) are defined as being valid.

Another example is as follows:
Select (Requests2):
   Request_type=Availability AND
   POS=(Travel_agency1 OR Booking_agents) AND
   Origin=New York City AND
   Destination=Hong Kong AND
   Depart_date=November 23-27

In this case, only those availability requests submitted from designated points-of-sale (POS) are considered. These points-of-sale include one or more travel agencies designated “Travel_agency1”, or the airline's booking agents, referred to as “Booking_agents”. As may be appreciated, this rule excludes all availability requests issued from other sources such as personal computers located in a potential customer's home. In addition, the availability requests of interest must be requesting travel from New York to Hong Kong during November 23 through November 27.

Yet another example utilizes different types of data to capture certain booking requests:
Select (Requests3):
   Request_type=Booking AND
   Status=Not_booked AND
   Best_fit_flight=XYZ

This rule, which assumes that data fields “Status” and “Best_fit_flight” have been defined within request data 226, selects for capture all booking requests that were not booked, but for which the “best fit” flight (had it been available) is flight “XYZ”. Recall that in one embodiment, this “best fit” flight is included in a list of flights provided by routing module 218 to demand recording module 220 on interface 302A. This rule may be useful in determining the “lost demand” (that is, the number of lost sales because of flight unavailability) that is associated with unavailability of seats on a particular flight.

While the foregoing rules are of a type that would be used by request filter logic 312 to determine which requests to capture, similar rules may be defined for use by data filter logic 316 in determining which data to capture for each selected request. For example, consider the following:
Save (Requests1):
   Request_type AND
   POS AND
   Depart_date AND
   Origin AND
   Destination AND
   Best_fit_flight

This type of rule indicates the fields that are to be saved for requests of type “Requests1” as will be interpreted by data filter logic 316. This type of rule may be defined to determine the types of data to be stored for a respective request type, or for more than one request type. If desired, the same rule may be used to determine the data that is to be stored for multiple, or all, request types.

Similar types of business rules may be defined for each of the logic sections, including notification module 217, enabling logic 320, and report generation logic 328. For example, the following notification trigger event rule may be defined:
Notify1 if Rate (Requests1)>60

This rule assumes that a function “Rate” has been defined to calculate a rate at which requests of the specified type are being received. For instance, the rate may be calculated based on the number of requests received per hour. In the current example, when the rate of receipt of requests of type “Requests1” exceeds “60” within the predetermined time period, the trigger event has occurred and the notification action “Notify1” is taken. This notification action is defined by an additional notification action rule as follows:
Notify1: email message1 address_list1

This notification action rule associates the character string “Notify1” with the notification action of issuing an email message containing the text associated with “message1” to all of the personnel associated with the address list “address_list1”. The text message and address list is assumed to have been pre-defined.

In the foregoing manner, a trigger event rule and associated notification action rule may be defined to cause a notification to be issued when any type of event associated with availability and/or booking request data is detected.

The current invention further provides the capability to selectively enable and/or disable the use of one or more other rules. For instance, an enabling rule may be defined to enable use of the rule for “Requests1” set forth above. It may be desirable, for instance, to enable the capturing of such requests on a specified date, as follows:
Enable Requests1 if (Date>Oct. 31, 2005)

This rule is interpreted by enable logic 320 to enable the request filter logic 312 to begin capturing requests of type “Requests1” after Oct. 31, 2005. Before this time, the selected type of availability requests as determined by the rule for “Requests1” will not be captured.

As noted above, an enabling rule may be stored and interpreted by enabling logic 320. This logic either includes dedicated rules engine logic for interpreting such rules, or is coupled to common rules engine logic of a type that may be shared between enable logic 320, request filter logic 312, data filter logic 316, and notification module 217.

In a similar manner, a disabling rule may be defined for use by enabling logic 320. Such a rule may indicate that one or more other rules are to be taken out of use. For example, a disabling rule may disable use of the rule for “Requests2” after a particular time and date.

Multiple rules may be defined for any given logic section, if desired. In one embodiment, the rules may be stored in storage space allocated to the respective logic section, or may instead be stored as business rules 230 (FIG. 2). Remote stations 104 may include a graphical user interface (GUI) that facilitates the definition of these business rules.

It may be noted that the syntax used to illustrate the foregoing rules is merely intended for discussion purposes and to exemplify concepts. It will be understood that this syntax is largely arbitrary and many other types of syntax may be used to express these concepts. Moreover, while the foregoing examples utilize a pseudo English language format for ease of reference, it will be appreciated that when these rules are stored as business rules 230 or elsewhere within the system, they are expressed in a digital format (e.g., as a series of ones and zeros) that may be interpreted by the software, firmware, microcode, and/or hardware used to implement the other logic sections of the system, and specifically, the rules engine logic.

A user may define the rules using a rules language such as that described above, which is similar to a programming or query language. Alternatively, these rules may be defined using the help of a Graphical User Interface (GUI) that is provided as one of user interface modules 234 (FIG. 2) executing on remote stations 104 and/or user interface modules 201 on web servers 200. If this type of interface is used, the user need not, in general, become familiar with any type of rules language, since the GUI interface will format the rules as the GUI operators (e.g., drop-down menus, radios, buttons, etc.) are selected.

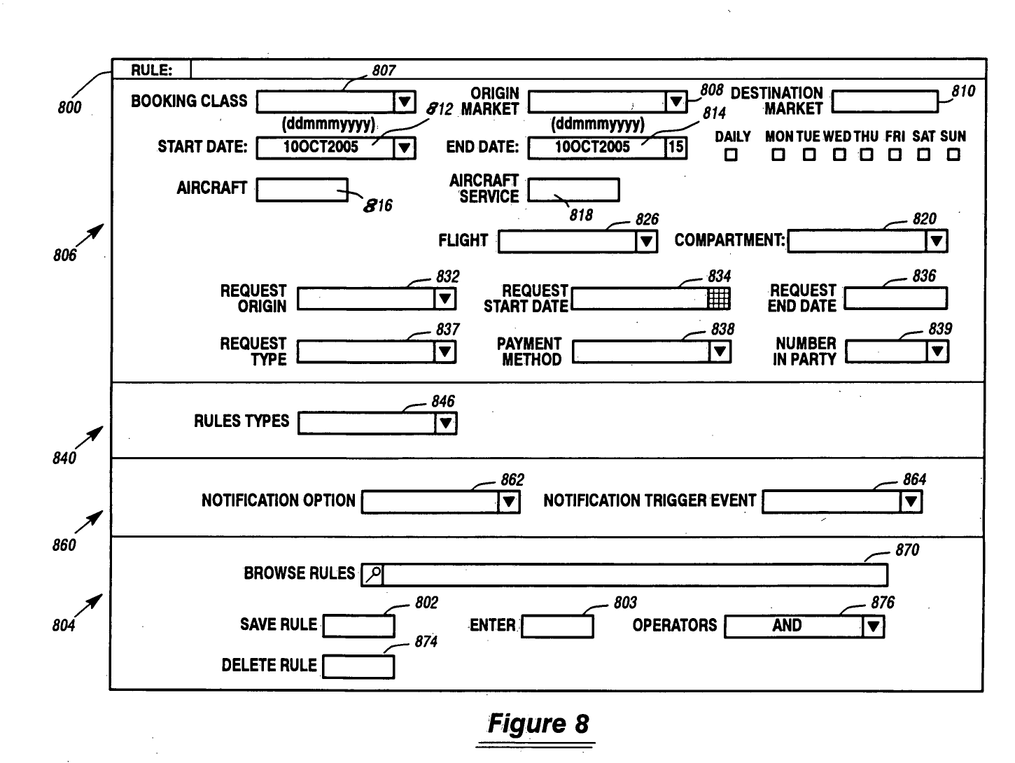

FIG. 8 is a diagram illustrating an exemplary screen such as may be used to define programmable rules within a system that employs a graphical user interface (GUI). A window 800 is used to display a rule that is under definition by an authorized user such as an authorized airline inventory control agent. Data fields and values to be referenced by a rule are selected using drop-down menus and other GUI utilities such as radios, buttons, browse functions, and so on. When the definition has been completed, it may be saved, if desired, by selecting the “Save Rule” button 802 of screen area 804. In one embodiment, this causes the rule to be saved within business rules 230 of database systems and/or provided directly to an applicable module.

When defining a rule, the rule type is first selected using drop-down menu 846 of screen area 840. Rule types may include, but are not limited to, a type that selects the requests to be captured, a type that selects the data to be captured, a type to enable or disable either the request selection and/or data saving capabilities, a type to define a notification trigger actions, and so on.

Screen area 806 provides various GUI functions for use in selecting the types of booking and availability requests to capture, and/or the types of request data to save. For instance, drop-down menus 807, 808 and 810 may be provided to allow selection of a booking class, an origin, and a destination for a group flights. Origin and destination selections available via menus 808 and 810 may include cities, airport codes, states, countries, continents, and/or other geographic designations as determined by the interface designer.

Also included in screen area 806 are start date and end date input areas 812 and 814, respectively. These input areas allow a date range to be specified for selecting flight departure dates. If desired, specific days of the week may be selected to limit these date ranges. Thus, for instance, the selection may be limited to requests specifying flights departing on one of the selected days of the week within the specified date range.

Other information provided for selecting availability and booking requests includes types of aircraft, compartments, and actual flight numbers. These are selected using input areas 816, 820, and 826, respectively. Requests that specify a special service (e.g., “unaccompanied minor”) may be selected using menu 818. Other selections may include the origin (or POS) of the request, which is selected using menu 832. A request date range may be specified using menus 834 and 836 so that only requests submitted during that time period will be considered. Other possible request selection criteria may include a payment method associated with the request (e.g., Visa, MasterCard, etc.), and the number of people associated with the request. This information is selected using menus 838 and 839, respectively.

When the “Enter” key 803 of screen area 804 is selected, the various data selections made within screen areas 804, 806, 840, and 860 appear as a draft of a rule within window 800. In one embodiment, the selections made within a particular screen area such as screen area 806 are, by default, connected by a predetermined Boolean operator such as “AND”. This default situation can be overridden by positioning a cursor within window 800 and modifying the operator. Alternatively, the default Boolean operator may be modified using menu 876 of window 804.

Multiple data items of the same type may be selected, if desired. For instance, if multiple flights are to be selected within the same rule, a first set of data selections containing the first flight number is entered into screen area 806 and the “Enter” button 803 is selected. This causes the initial rule definition to appear in window 800. A different flight number may then be selected using drop-down menu 826, and the desired Boolean operator may be selected (for instance, the “OR” operator) using menu 876. Selection of the Enter button 803 causes the additional flight number of be appended to the rule after the first flight number and separated by the desired Boolean operator (e.g., “OR”). This will be shown in window 800. This process may be repeated any number of times. When this process is completed, the rule may be stored along with a desired label (e.g., “Requests1”) that may be provided by the user via keyboard entry, for instance. Saving of the rule is initiated by selection of the “Save Rule” button 802. At this time, the system may check rule syntax and issue a warning message if improper syntax was used, as may occur if the user is updating the rule manually within window 800.

As noted above, screen area 840 includes a menu 846 to specify rule types. Screen area 860 provides drop-down menu 862 to select notification options such as email, fax, pager, printer, and/or other automatically-generated transmissions to be used in notification action rules. Another drop-down menu 864 is provided to select a notification trigger event to be associated with the notification action rule. These trigger events must be pre-defined, as may be accomplished using another GUI screen that is similar to that shown in FIG. 8.

As discussed above, screen area 804 includes various general-purpose utilities such as the “Save rule” button 802 that is used to save the rule appearing in window 800 when a definition is considered complete. The “Browse rule” window 870 allows a user to browse previously defined rules so that they can be incorporated into an applicable rule. An authorized user may decide to delete a previously-defined rule highlighted in window 870 using the “Delete rule” button 874. Drop-down menu 876 allows a user to select Boolean operators (e.g., AND, OR, NOT) for inclusion in the rules, as mentioned above.

The exemplary screen of FIG. 8 provides a very simple illustration of one screen of a GUI interface that may be utilized to define rules according to one embodiment of the current invention. Any of the data types stored within database systems 204 may be represented within this type of GUI interface, including, but not limited to, those types described herein. It will be appreciated that a suitable interface may have many screens that may be similar to that shown in FIG. 8 for providing all of the necessary input areas. For instance, for ease of reference, this figure does not illustrate a window for report definitions, or for defining the notification options such as the device and path names, email address lists, and so on, that are used to generate the notification. Other similar windows may be defined to support entry of these types of rules. Moreover, many alternative user interfaces may be provided for the current system and method, including an interface that supports rules creation using a rules-definition language such as that illustrated above.

The invention is susceptible to various modifications and alternative forms. Specific embodiments thereof have been shown by way of example only. For instance, many variations of the methods that are described herein are possible. Some of the steps may be deleted, and many of the steps may be re-ordered. These steps may be performed in hardware, software, firmware or any combination thereof.

In addition to the foregoing, it will be noted that while the above discussion relates primarily saving and utilizing request information for an airline, this is merely for ease of reference. Any other transportation carrier such as a bus company, cruise line, train service, or the like, may usefully employ the current invention. Similarly, other services industries may utilize the system and method to control the sale of services and maximize revenues. For instance, a hotel or resort chain may employ a similar system based on programmable rules to control the sale of rooms based on request information. As another example, a service that specializes in the sale of seats for public events such as sporting engagements, concerts, or other similar activities may utilize the current system and method.

Thus, it should be understood that the detailed description is not intended to limit the invention to the particular forms disclosed. On the contrary, the intention is to cover all modifications, equivalents, and alternatives falling within the spirit and scope of the invention as defined by the appended claims.

What is claimed is:

1. A computer-implemented method for capturing data for a transportation carrier, comprising:
receiving a request;
determining, irrespective of whether the request will result in the sale of a service provided by the transportation carrier, whether the request is of a type for which associated data should be captured; and
storing the associated data.

2. The method of claim 1, wherein the request is selected from the group consisting of availability requests and booking requests.

3. The method of claim 1, further including determining the associated data that should be stored.

4. The method of claim 3, wherein at least one of the determining steps is performed using programmable business rules.

5. The method of claim 1, and further including automatically generating a notification to at least one of an authorized agent of the transportation carrier and a potential passenger based on the associated data.

6. The method of claim 5, wherein the notification is automatically generated in a manner that is based on programmable business rules.

7. The method of claim 1, and further including automatically generating a report that includes programmably selected portions of the associated data.

8. The method of claim 1, wherein the determining step is based on one or more factors selected from a group consisting of:
an origin of the request;
a date the request was submitted;
a time the request was submitted;
a date of departure for the requested service;
a time of departure for the requested service;
an origin for the requested service;
a destination for the requested service;
whether the request was submitted based on price or schedule;
a compartment specified by the request;
a booking class specified by the request;
a list of services that, if available, could be booked to fulfill the request;
a list of available services that could be booked to fulfill the request;
a type of request;
information describing a requester that submitted the request; and
a number of people associated with the requested service.

9. The method of claim 3, wherein the type of associated data to be stored is selected from a group consisting of:
an origin of the request;
a date the request was submitted;
a time the request was submitted;
a date of departure for the requested service;
a time of departure for the requested service;
an origin for the requested service;
a destination for the requested service;
whether the request was submitted based on price or schedule;
a compartment specified by the request;
a booking class specified by the request;
a list of services that, if available, could be booked to fulfill the request;
a list of services that are available to fulfill the request;
a type of request;
information describing a requester that submitted the request; and
a number of people associated with the requested service.

10. The method of claim 1 including at least one of a group consisting of:
compiling a first list of services that, if available, could be booked to fulfill the request and storing the first list as a portion of the associated data; and
compiling a second list of available services that are available to fulfill the request and storing the second list as a portion of the associated data.

11. The method of claim 1, including providing the associated data to a demand forecasting system for use in performing demand forecasting.

12. The method of claim 3, including at least one of a group consisting of:
interpreting one or more business rules to enable one or more of the determining steps during respectively selected times; and
interpreting one or more business rules to disable one or more of the determining steps during different respectively selected times.

13. An automated system for use by a transportation carrier in processing requests associated with services provided by the transportation carrier, the system comprising:
a demand recording module for automatically storing selected requests based on data associated with the selected requests and without regard as to whether any of the selected requests resulted in a sale of any of the services; and
a storage facility coupled to the demand recording module to store information for the selected requests.

14. The system of claim 13 including request filter logic to select the selected requests based on programmable settings.

15. The system of claim 14, wherein the programmable settings take into account one or more factors selected from the group consisting of:
an origin of a request;
a date a request was submitted;
a time a request was submitted;
a date of departure for a service selected by a request;
a time of departure for a service selected by a request;
an origin for a service selected by a request;
a destination for a service selected by a request;
whether the request was submitted based on price or schedule;
any compartment specified by a request;
any booking class specified by a request;
a list of services that, if available, could be booked to fulfill a request;
a list of available services that are available to fulfill a request;
a type of a request;
information describing a requester that submitted a request; and
a number of people associated with a service selected by a request.

16. The system of claim 13 including data filter logic to select the information to be stored for the selected ones of the requests based on programmable settings.

17. The system of claim 16, wherein the programmable setting take into account one or more factors selected from the group consisting of:
an origin of a request;
a date a request was submitted;
a time a request was submitted;
a date of departure for a service selected by a request;
a time of departure for a service selected by a request;
an origin for a service selected by a request;
a destination for a service selected by a request;
whether the request was submitted based on price or schedule;
a compartment specified by a request;
a booking class specified by a request;
a list of services that, if available, could be booked to fulfill a request;
a list of services that are available to fulfill a request;
a type of a request;
information describing a requester that submitted a request; and
a number of people associated with a service selected by a request.

18. The system of claim 13 including a notification module coupled to the demand recording module to automatically notify at least one of an employee or a customer of the transportation carrier based on the information stored for the selected requests in a manner determined by programmable settings.

19. The system of claim 13 including report generation logic coupled to the demand recording module to automatically initiate creation of one or more reports that include selected portions of the information stored for the selected requests.

20. The system of claim 13 including at least one of a group consisting of:
a routing module coupled to the demand recording module to determine a set of one or more routes that are suited to satisfy the requests; and
a booking module coupled to the demand recording module to determine a set of one or more available routes that satisfy the requests; and
wherein demand recording module includes logic to store at least one of the set of one or more routes and the set of available routes.

21. An automated system for capturing information describing demand for transportation services, comprising:
programmable request means for receiving requests associated with, but not resulting in sale of, the transportation services, and for selecting information to be stored for selected ones of the received requests; and
storage means for storing the selected information.

22. The system of claim 21, wherein the programmable request means includes:
programmable request filter means for selecting the selected ones of the received requests; and
programmable data filter means for selecting the information to be stored for the selected ones of the received requests.

23. The system of claim 21 including notification means for automatically issuing one or more notifications based on the information stored for the selected ones of the received requests.

24. A computer readable medium having a program to cause a system utilized by a transportation carrier to execute a method comprising:
receiving requests associated with, but not purchasing, services provided by the transportation carrier;
determining whether the received requests are of a type selected for capture; and
for each of the requests that are of the selected type, storing selected information describing the request to a storage facility.

25. The medium of claim 24, wherein the determining step is accomplished using programmable rules that are selected from a group consisting of:
rules to determine one or more types of requests selected for capture; and
rules to determine the selected information.

26. The medium of claim 24, including providing the selected information to a demand forecasting system for use in determining demand for the services provided by the transportation carrier.
